(19) United States
(12) Patent Application Publication
(10) Pub. No.: US 2003/0173045 A1
(43) Pub. Date: Sep. 18, 2003

(54) Liquid starch dispersions for coated paper and paperboard

(76) Inventors: Philip Confalone, Raritan, NJ (US); Daniel B. Solarek, Hillsborough, NJ (US); Aqnieszka Lapinska, Trenton, NJ (US); Wayne Kibble, Hixson, TN (US)

Correspondence Address: Thomas F. Roland, NATIONAL STARCH AND CHEMICAL COMPANY, P.O. Box 6500, Bridgewater, NJ, 08807-0500, US

(21) Appl. No.: 10/100,828

(22) Filed: Mar. 18, 2002

(51) Int. Cl. D21H 19/54; C08B 31/00; C08B 35/00; C08L 3/04; C08L 3/14; C 09D 1 3/02

(52) U.S. Cl. 162/135; 162/175; 162/158; 106/209.1; 106/207.1; 536/102; 536/110; 428/533

(57) ABSTRACT

The present invention relates to a liquid starch dispersion for paper coating where the dispersion has 5 to 50 percent by weight of starch, and the starch contains from 20 to 100 percent by weight of at least one cationic starch. The liquid starch composition is characterized in that a 25 percent by weight starch solids dispersion has a 25° C. viscosity of from 500 to 2500 cps both initially, and also upon storage at room temperature for 90 days. The dispersion preferably contains a blend of cationic starch and ASA starch. The liquid starch dispersion is useful in paper and paperboard coating processes, as a rheology modifier, a structurant, and/or a binder, all at the same time. The liquid starch dispersion provides good coating holdout, gloss, and stiffness properties. The cationic nature of the starch coating improves printability with anionic inks, and makes the coatings useful for ink-jet and photographic papers.

### FIELD OF THE INVENTION

This invention relates to a liquid cationic starch dispersion that maintains a stable viscosity for a period of at least 90 days. The liquid starch dispersion is useful in paper and paperboard coating processes, as a rheology modifier, a structurant, and/or a binder, all at the same time. The liquid cationic starch solution may also contain other varieties of starches.

### BACKGROUND OF THE INVENTION

Polymers, both natural and synthetic, are used in several different aspects of the paper-making process. They are used for sizing, both internal and external on the paper press operation. Sizes are mixed with fillers and fibers for the purpose of binding the various components together during the wet paper making operation wherein the process is known as internal sizing. Sizing compounds may also be applied to the surface of the finished web or sheet in which case the process is known as external or surface sizing. An external size is added to change the porosity of the paper, stiffen the fibrous web, provide resistance to picking, increase resistance to water/ink penetration and to improve the smoothness and optical characteristic of the paper. Sizing involves a saturation process with large amounts of sizing agent relative to the filler (i.e. pigment). Sizing compositions comprising a blend of cationic starches and alkyl or alkenyl succinic anhydride (ASA) starches are described in U.S. Pat. No. 4,872,951.

Starches have long been used in paper coating applications. The starches used in coatings are modified starches, since unmodified starches used in concentrations needed for effective binding are too viscous for practical use. U.S. Pat. No. 3,884,853 describes an amphoteric starch for such a purpose. U.S. Pat. No. 5,080,717 describes a multi-polysaccharide paper coating composition which could contain a cationic starch. U.S. Pat. No. 5,399,193 describes a paper coating binder having either a cationic starch, or a cationic polymer, in combination with a non-ionic substituent. The preferred nonionic group is an ester or a hydroxyalkyl group. The starch blends, as shown in the examples, are in a powdered form, that is solubilized with the pigment just prior to use.

Natural and synthetic polymers may also be used in the coating of paper and paperboard. A coating is applied to the paper or paperboard to cover the fibrous paper surface and to produce a smoother and less absorbent surface on which to apply printing inks and other functional coatings. The coating composition typically comprises naturally occurring or man-made pigments, synthetic coating binders, water, and small amounts of miscellaneous additives. The pigments are used to fill and smooth the uneven surface of the fibrous paper web, while the binder is used to hold the pigment particles together, and to hold the coating layer to the paper. Typical binders are composed of synthetic polymers, starches, proteins, or a mixture of these components.

Starch and proteins currently used as coating additives are supplied in dry powder form and require water, shear, temperature, time, and sometimes alkali (protein only) to solubilize them. In the case of proteins, an alkali such as ammonium hydroxide is sometimes used as a solubilizing agent, which presents objectionable odors in the work place and adds to volatile organic compounds (VOCs).

One way to overcome the difficulties, time, and expense involved in solubilizing the powdered binders, is to have the binder supplied in a liquid form. This simplifies coating preparation, frees up manpower, and reduces energy costs and house cleaning. Unfortunately starch or protein binders sold as pre-prepared aqueous solutions require biocide to be added to prevent spoilage, and they must generally be consumed quickly since they tend to thicken on standing.

There is a need for a natural coating polymer that is supplied in a liquid ready-to-use form, that overcomes the problems associated with current liquid natural polymers. Surprisingly it has been found that cationic starch from waxy maize, prepared in the proper manner and with specified levels of nitrogen, fluidity, and solids provides a stable ready to use liquid starch dispersion. The aqueous starch dispersion can contain a range of starch compositions, in different ratios, thus providing a family of multifunctional, ready-for-use liquid starch polymers for coated paper or paperboard applications. An added advantage is that when used in pigmented coating formulations, the starch blends can function as rheology modifiers, structurants, and/or binders under near neutral pH conditions. They also contribute to specular gloss, both before and after printing. The cationic starch dispersions can also be used as economical extenders for protein, casein, and other more expensive additives that impart cationicity to coating colors.

### SUMMARY OF THE INVENTION

The present invention is directed to a liquid starch dispersion for paper coating where the dispersion comprises 5 to 50 percent by weight of starch, said starch comprising from 20 to 100 percent by weight of at least one cationic starch, and the liquid starch composition is characterized in that a 25 percent by weight starch solids dispersion has a 25° C. viscosity of from 500 to 2500 cps both initially, and also upon storage at room temperature for 90 days. The dispersion preferably contains a blend of cationic starch and ASA starch.

The invention is also directed to a paper or paperboard coating composition comprising:

a) 0.5 to 25 percent by weight of a starch blend comprising from 25 to 95 percent by weight of at least one cationic starch, and from 5 to 75 percent by weight of at least one alkenyl succinic anhydride (ASA) modified starch.

b) 25 to 75 percent by weight pigment; and

c) water.

The coating composition may also contain from 2 to 20 percent by weight of at least one synthetic binder, and from 0.5 to 1.5 percent of miscellaneous additives.

The invention is further directed to a coated paper or paperboard that is coated with the coating composition containing the liquid starch, and also to a process for producing coated paper paperboard coated with the liquid starch.

### DETAILED DESCRIPTION OF THE INVENTION

The present invention relates to a stable liquid starch dispersion, where the starch is from 20 to 100 weight percent of a cationic starch. The starch dispersion is characterized in that a 25 percent solids starch dispersion has a stable 25° C. viscosity of from 500 to 2500 cps measured both initially, and after 90 days at room storage at or room temperature (25° C.).

The starch dispersion of the invention contains at least one cationic starch. All of the cationic starch is derived from a starch source having at least 90 percent amylopectin, and preferably a waxy maize. A cationic corn starch would not be useful, since the high amylose component would not provide for a stable dispersion. The cationic starch is prepared, for example, by reacting starch through an etherification or esterification reaction with any reagent that will introduce a cationic group containing nitrogen, sulfur, or phosphorus thereon. Examples of such groups are the amine (primary, secondary, tertiary, or quaternary), sulfonium and phosphonium groups. The preferred cationic starch derivative is the tertiary amino alkyl ester resulting from the reaction of a starch under alkaline conditions, with a dialkyl amino alkyl halide. Other cationic starches useful herein are described in U.S. Pat. No. 4,872,951, incorporated herein by reference. The starch-amine products may be subsequently treated by known methods so as to result in the quaternary ammonium salt, or such a quaternary ammonium salt may be made directly from a starch, for example, by treating it with the reaction product of an epihalohydrin and a tertiary amine or tertiary amine salt. The resulting starch derivative is cationic in nature, and useful in the present invention. The degree of substitution in the cationic starch derivatives of the invention ranges from 1 to 20 percent, and preferably from 2 to 10 percent. The level of cationic character chosen depends on the desired end use for the liquid starch dispersion.

The cationic starch makes up from 20 to 100 percent of the starch in the dispersion, and preferably from 30 to 90 percent by weight of the starch is cationic. The cationic starch functions to moderate the attractive forces between the coating starch and the other anionic ingredients that typically make up the coating formulation. Additionally, cationic starch functionality not tied up by anionic coating pigments and paper fibers are free to react with anionic printing inks. These ionic interactions may improve printability as measured by ink holdout, printed ink gloss, and print uniformity.

While the liquid starch dispersion may be 100 percent cationic starch, the dispersion is preferably a blend containing unmodified starch; a non-ionic starch containing groups such as esters or hydroxyalkyl groups, anionic starches such as a phosphonated starch; or a mixture thereof. Unmodified starches, are used only at low levels, if at all, due to the higher viscosity imparted to the dispersion by such starches.

Preferably the liquid starch dispersion contains a starch blend having from 5 to 75 percent by weight of an alkenyl succinic anhydride (ASA) modified starch. Preferred blends of cationic starch to ASA starch are 90/10, 70/30, 50/50, and 30/70 by weight ratio. The level of cationic character needed depends on the desired use of the liquid starch dispersion. It has been found that the inclusion of ASA starch in a coating formulation contributes to the flow properties (rheology) and the binding strength of the formulation.

The ASA-treated starches useful as binders herein are produced by the reaction of a starch with alkyl and alkenyl succinic anhydrides such as octenyl, decyl, or decenyl succinic anhydride, and dodecyl and dodecenyl succinic anhydride, where the alkyl or alkenyl group is preferably C₅₋₁₅. The starch to be modified may come from any plant source including corn, potato, sweet potato, wheat, rice, sago, tapioca, waxy maize, sorghum, high amylose corn, or the like. Additionally, conversion products derived from nay of these bases can be employed, including, for example, dextrins prepared by hydrolytic action of acid and/or heat; oxidized starches prepared by treatment with oxidants such as sodium hypochlorite; and fluidity or thin boiling starches prepared, for example, by enzyme conversion or mild acid hydrolysis. Preferably the base starch should have an amylopectin content of at least 90 percent. Preferably the ASA-treated starch are starch monoesters of octenyl succinate, prepared by the reaction of starch with 1-octenyl succinic anhydride by means known in the art. The starch is reacted with sufficient alkenyl succinic anhydride reagent in order that the resulting starch ester has a degree of substitution ranging from 0.005 to 0.10, preferably from 0.01 to 0.05, and most preferably from 0.0245 to 0.044.

Aqueous colloidal starch dispersions of the invention are made by solubilizing the starch, or starches, in water, by means known in the art. A preferred method of solubilizing the starch is by jet-cooking. Aqueous colloidal dispersions of starch blends may be made either by solubilizing each starch separately, then blending the solubilized dispersions, or by blending the starches into water first, followed by the solubilization process. It should be noted that jet-cooking of blended materials creates the potential for interactions between the materials, which may or may not be useful in the intended application.

Colloidal dispersions of the present invention are stable, meaning there is no change in the physical properties or spoilage over at least 90 days. In contrast, cooked starch and protein solutions tend to thicken quickly at room temperature. One key to stability is that the starch of the starch dispersion is primarily derived from starch having greater than 90 percent amylpectin. Stabilization is related to the prevention of retrogradation, and amylose-containing starches are more susceptible to retrogradation. The dispersions of the invention contain small amounts of a biocide as a preventative measure against mircobiological degradation during storage. Biocides known in the art, such as 1,2-dibromo-2,4-dicyanobutane, may be added to the dispersion for this purpose.

The colloidal dispersion can be characterized as having a viscosity of from 500 to 2,500 cps for a 25 percent solids dispersion measured by Brookfield viscosity at 20 rpm at 25° C. Preferably the viscosity is from 1000 to 2000 cps. The viscosity should change very little over 90 days of storage at room temperature. The fluidity of the dispersion is from 60 to 80 WF. The fluidity of the starch dispersion is sufficiently low to permit pumping, filtering, and mixing using typical paper and board making equipment. The dispersion is generally at neutral pH of from pH of 5.5 to 7.5, preferably 6.0 to 7. The starch dispersions have a solids level of from 10 to 50 percent, preferably 15 to 35 percent, and more preferably 20 to 30 percent. The starch dispersions of the invention resist foaming under high shear conditions.

The liquid starch dispersions are useful in the coating of paper. From 0.5 to 20 percent by weight of the coating composition, and preferably from 1 to 10 percent by weight of the wet coating composition is starch from the liquid starch dispersion of the invention. The liquid starch dispersion can serve as a rheology modifier, a structurant, and/or a binder, all at the same time. The starch dispersion may serve all three functions simultaneously, thereby saving the costs of using several different components.

As a rheology modifier, the liquid starch dispersion can modify the flow properties of a paper coating. As little as 1 percent by weight of the starch will effect the flow properties of coatings. While not being bound to any particular theory, it is believed that the type and amount of cationic charge on the starch backbone controls pigment dispersion, and therefore coating rheology. As the cationic charge increases, so does the apparent coating viscosity and the degree of thixotropy.

A structurant increases coating holdout on substrate surfaces during application, and has a bearing on the physical arrangement of pigments, binders and air spaces making up the dried coating layer. The liquid starch dispersions of the present invention improves coating holdout, affecting surface smoothness and substrate stiffness. This is especially important in light weight coated (LWC) paper. Coating structure also has an effect on uniform brightness and opacity. Additionally, the gloss for paper coated with the starch dispersions of the invention is greater than for coatings formulated with protein.

The liquid starch dispersion acts as a co-binder. The purpose of a binder and co-binder is to bind the pigment particles together, and also to bind the coating layer to he paper surface. The strength of the bond must be such that the coating layer is not detached, or picked, by the tacky printing inks. Because of its cationic nature, the liquid starch dispersion is generally not used as the sole binder. The liquid starch dispersion can be used in place of other natural polymers, such as soy protein, casein, and conventional starches, currently used as co-binders in paper coatings.

The liquid starch dispersion is combined with pigment and other additives to form a paper-coating formulation. A typical paper of board formulation contains 35 to 65 percent by weight of inorganic pigments like kaolin clays, talc, titanium dioxide, and calcium carbonate, with the choice of pigment based on the properties required in the paper surface; 0 to 4 percent by weight of synthetic pigments such as polystyrene; 2 to 20 percent by weight of synthetic polymer binders such as styrene butadiene, styrene acrylic polymers, and poly vinyl alcohol; 2 to 9 percent by weight of cobinders such as protein, casein, and starch; 0.1 to 1.5 percent by weight of other additives such as dispersants, insolubilizers (to improve wet strength); and 25 to 45 percent by weight of water.

The coating composition is formulated by combining the pigment, binder, cobinder and other additives with water. To avoid flocculation of anionic pigments or the formation of coating agglomerates during the preparation of the coating formulation, the dispersed pigment slurries should first be mixed with synthetic binders under low shear. The liquid starch dispersion is then added under the same shear conditions. The minor coating additives are generally added last.

Coating compositions containing the liquid starch dispersion can be applied to one or both sides of the paper by any means known in the art. Coating methods include, but are not limited to, roll applicator and metering with roll, rod, blade, bar, or air knife; pond applicator and metering with roll, rod, blade, bar, or air knife; fountain applicator and metering with roll, rod, blade, or bar, or air knife; premetered films or patterns (e.g., gate roll, three-roll, anilox, gravure, film press, curtain, spray); and foam application. The thickness of the coating is controlled by its composition, the ratios of each ingredient making up the coating formulation, and the coating methods. The paper or board making processes and the feedstock for said processes also influence coating thickness.

The coating composition may be formulated, as known in the art, for use in any paper or paperboard application. The multifunctional liquid cationic starch suspension of the invention is particularly valuable for its ability to function as rheology modifier, structurant, and/or binder, all at the same time in pigmented coating formulations. The liquid starch dispersion is especially useful in coated papers for ink-jet applications, due to the cationic nature of the starch. The good gloss properties found in paper coatings of the invention, plus the ability of the cationic starch to improve printability, ink holdout, and print uniformity, make the liquid starch dispersions useful in producing papers for printing photographs from ink jet and laser printers.

The following examples are presented to further illustrate and explain the present invention and should not be taken as limiting in any regard.

### EXAMPLE 1

A liquid starch blend is made by blending together into a slurry:

185 parts by weight of water

90 parts by weight of a cationic starch, 1.9 percent Quat treated with 3-chloro-2-hydroxypropyl trimethyl ammonium chloride on 70 WF waxy

10 parts by weight of an OSA starch, 3 percent OSA on 70 waxy.

The pH of the blend is adjusted to between 6.0 and 6.5 with 3 percent sodium hydroxide. The slurry is then jet-cooked, maintaining the temperature at 290-300° F. The solids are adjusted, if necessary, by diluting to 25 to 27 percent solids with water. The slurry is cooled to below 40° C. and 0.3 percent by volume of TEKTOMER 38LV biocide added. This produces a 90/10 Cationic/OSA starch blend at a solids level of 25-27 percent.

### EXAMPLE 2

A blend was made in a similar manner as in Example 1, in the ratio of 70/30 Cationic/OSA by weight.

### EXAMPLE 3

A blend was made in a similar manner as in Example 1, in the ratio of 50/50 Cationic/OSA by weight.

### EXAMPLE 4

A blend was made in a similar manner as in Example 1, in the ratio of 30/70 Cationic/OSA by weight.

### Comparative Example 1

Soy Protein

A dry form soy protein, PROCOTE 400 from Dupont, was cooked to 25 percent by weight solids in the following manner. In a ventilated hood, a prescribed amount of dry soy protein is slowly added to a stainless steel container of warm water (150° F.) under enough mechanical agitation to achieve a medium vortex thus preventing a build up of undispersed protein (1) at the air liquid interface and, (2) along the surfaces of said container and (3), on the agitator shaft and impeller. After 15 minutes mixing at 150° F., a dilute solution of alkali is slowly added to the said container (15% Ammonium Hydroxide, dry on dry) to solubilize the soy protein. Solubilized protein is mixed for an additional 30 minutes at 150° F. The final solids content of the solubilized protein is 25 percent and the pH is approximately 9.5

When preparing coating colors, warm solubilized protein is added to stainless steel vessels containing pigments, cobinders, and dilution water under enough mechanical agitation to achieve a medium vortex thus preventing a build up of protein as noted above or coagulation of the coating color. The pH of finished coatings comprising protein is between 8.5 and 9.5.

### Comparative Example 2

Ethylated Starch

An dry form 80 WF ethylated starch, K580 from Grain Processing Corporation, was cooked to 25 percent by weight solids in the following manner. Fill a stainless steel container with the appropriate amount of water. Start the mixer to create a medium-sized vortex. Slowly add prescribed amount of dry starch to avoid buildup (same as noted above). Let this slurry mix for 15 minutes while maintaining a medium-sized vortex. After 15 minutes, slowly raise the temperature of the starch slurry to 200-205° F. while mixing. Continue cooking the starch for 30 minutes at 200-205° F. while maintaining a small vortex. Discontinue heating and let the cooked starch cool (140° F.) before testing its viscosity and before adding it to the coating under low shear conditions.

### Comparative Example 3

Cationic Corn Starch

A dry form cationic corn starch, CATO 75Q from National Starch and Chemical Company was cooked to 25 percent by weight solids, using the procedure in Comparative Example 2.

### Comparative Example 4

Cationic Liquid Starch

A 25 percent cationic waxy liquid starch, CATOSIZE 270, was obtained from National Starch and Chemical Company.

### EXAMPLE 5

The Brookfield viscosity of the starch and protein dispersions at 25 percent by weight solids was measured at 20 rpm at several different times: initially at 140° F., after 24 hours at 72° F., and at 72° F. for 100 days. The results are summarized in Table I. Comparative Example 4 at 100 days was phased, meaning the dispersion separated into distinct liquid layers, having different solids contents. Examples 1 and 4 showed no phasing or separation at 100 days.

TABLE I

| | | | Comp Ex 3 | Comp Ex 4 | Example 1 | |
|---|---|---|---|---|---|---|
| | Comp Ex 1 | Comp Ex 2 | Cationic | Cationic | 90/10 blend | Example 4 |
| | Soy | Ethylated | corn | waxy liquid | Cationic/OS | 30/70 blend |
| | Protein | starch | starch | starch | A | Cationic/OSA |
| Initial | 1795 cps | 62 cps | 1136 | 256 | 1290 | 1460 |
| 24 | 104,200 | 1240 cps | gelled | 258 | 1255 | 1440 |
| Hour | cps | | | | | |
| 100 | Not tested | Gelled at | Not tested | 390 phased | 1600 | 1720 |
| days | | 48 hours | | | | |

### EXAMPLE 6

Rheology of Coating Compositions

Coating compositions were formed by blending on a solids basis by weight: 100 parts of number 1 clay, 12 parts styrene butadiene latex, and 4 percent of the co-binder to produce a 58 percent solids dispersion at a pH of 7.5 (except for the protein which was at pH 9.0). The dispersions were tested for low shear viscosity and stability on 24 hour aging using a Brookfield RVF Viscometer at 20 rpm and 80° F. High shear viscosity was measured using a Hercules Rheometer, E bob, 400 K dyne spring at 4400 rpm and at 80° F. Water retention was measured using an AA-GWR water retention meter. The result are shown in Table II and III:

TABLE II
LOW SHEAR VISCOSITY AND STABILITY ON AGING

| Co-binder | Initial Visc., cps | 24 hour Visc., cps | % Increase |
|---|---|---|---|
| Example 1 | 2188 | 2828 | 29.3 |
| Example 2 | 1982 | 2516 | 26.9 |
| Example 3 | 1896 | 2368 | 24.9 |
| Example 4 | 1334 | 1636 | 22.6 |
| Comp Ex 1 | 1874 | 3008 | 60.5 |
| Comp Ex 2 | 1026 | 1283 | 25.0 |

TABLE III
HIGH SHEAR VISCOSITY AND WATER RETENTION

| Co-binder | Apparent Visc., cps | Water Retention, g/m² |
|---|---|---|
| Example 1 | 29.4 | 105 |
| Example 2 | 28.0 | 106 |
| Example 3 | 27.3 | 109 |
| Example 4 | 23.1 | 119 |
| Comp Ex 1 | 30.1 | 107 |
| Comp Ex 2 | 15.4 | 107 |

### EXAMPLE 7

LWC Smoothness and Stiffness, Pre/Post Supercalendering

Coating compositions were formed by blending on a solids basis by weight: 100 parts of number 1 clay, 10 parts styrene butadiene latex, and 7 parts total co-binder to produce a 55 percent solids dispersion at a pH of 8.0. The cobinder was 70 percent starch of Comparative Example 2 and 30 percent liquid Starch of Examples 1-4. The control cobinder was 100 percent starch of Comparative Example 2. The coating composition was used at 4.5-lbs/3300 sq. ft. The properties measured were the Parker-print Smoothness (S.10) and Gurley Stiffness normalized to constant paper density to account for caliper and coat weight. Properties were measured both before and after supercalendering. The results are shown in TABLE IV:

TABLE IV
COATING SMOOTHNESS AND STIFFNESS

| | |
|---|---|
| Roughness, microns | Stiffness, g/ream |

| Co-binder | Before | After | Before | After |
|---|---|---|---|---|
| Control | 6.2 | 2.9 | 0.25 | 0.13 |
| Example 1 | 6.4 | 2.3 | 0.33 | 0.18 |
| Example 2 | 6.4 | 2.3 | 0.32 | 0.16 |
| Example 3 | 6.2 | 2.4 | 0.28 | 0.15 |
| Example 4 | 6.1 | 2.6 | 0.27 | 0.15 |

### EXAMPLE 8

Brightness and Opacity, Pre/Post Supercalendering

Coating compositions were formed by blending on a solids basis by weight: 100 parts of number 1 clay, 10 parts styrene butadiene latex, and 7 parts total co-binder to produce a 55 percent solids dispersion at a pH of 8.0. The cobinder was 70 percent starch of Comparative Example 2 and 30 percent liquid Starch of Examples 1-4. The control cobinder was 100 percent starch of Comparative Example 2. The coating composition was used at 4.5-lbs/3300 sq. ft. The properties measured were the TAPPI Brightness and Opacity. The properties were measured both before and after supercalendering. The results are shown in TABLE V:

TABLE V
COATING SMOOTHNESS AND STIFFNESS

| | |
|---|---|
| Brightness | Opacity |

| Co-binder | Before | After | Before | After |
|---|---|---|---|---|
| Control | 70.5 | 69.4 | 79.0 | 78.0 |
| Example 1 | 71.0 | 70.6 | 80.7 | 79.9 |
| Example 2 | 70.7 | 70.2 | 80.1 | 79.4 |
| Example 3 | 70.6 | 70.0 | 79.9 | 79.3 |
| Example 4 | 70.6 | 69.8 | 79.6 | 78.8 |

### EXAMPLE 9

Coated Board Gloss and Gloss Mottle

Coating compositions were formed by blending on a solids basis by weight: 100 parts of number 1 clay, 12 parts styrene butadiene latex, and 4 parts co-binder to produce a 58 percent solids dispersion at a pH of 7.5 (except for the protein coating at pH 9.0). The coating composition was used at 3.3-lbs/1000 sq. ft and gloss calendered one nip. The properties measured were the 750° Hunter Gloss and the Gloss Mottle Index reported as the standard deviation for the gloss data at 95 percent confidence. The results are shown in TABLE VI:

TABLE VI
COATED BOARD GLOSS AND GLOSS MOTTLE

| Co-binder | 75° Hunter Gloss | Gloss Mottle Index |
|---|---|---|
| Comp. Ex 1 | 46.3 | 2.2 |
| Example 1 | 50.0 | 2.0 |
| Example 2 | 51.4 | 2.3 |
| Example 3 | 51.9 | 2.9 |
| Example 4 | 53.7 | 3.2 |

### EXAMPLE 10

Coated Board Printability and Glueability

Coating compositions were formed by blending on a solids basis by weight: 100 parts of number 1 clay, 12 parts styrene butadiene latex, and 4 parts co-binder to produce a 58 percent solids dispersion at a pH of 7.5 (except for the protein coating at pH 9.0). The properties measured were the Print Gloss by 75° Hunter Gloss units with the SFO Process Blue optical density of 1.89; the dry pick resistance with IGT #5 ink, 5 m/s, 50 KgF, cm/sec; The wet pick resistance as a Vandercook Proofing Press Rating of 1-10, with a 0 being no pick; and glueability or set speed as time (in seconds) to achieve 100 percent fiber tear with aqueous carton adhesive. The results are shown in TABLE VII:

TABLE VII
COATED BOARD PRINTABILITY AND GLUEABILITY

| Co-binder | Print Gloss | Dry Pick | Wet Pick | Set Speed |
|---|---|---|---|---|
| Comp. Ex 1 | 60.7 | 218 | 5 | 30 |
| Comp Ex 2 | 65.2 | 149 | 9 | 70 |
| Example 1 | 63.7 | 237 | 5 | 30 |
| Example 2 | 65.1 | 218 | 5 | 30 |
| Example 3 | 64.2 | 209 | 5 | 40 |
| Example 4 | 63.3 | 196 | 6 | 50 |

What is claimed is:

1. A liquid starch composition for paper coating wherein said composition comprising 5 to 50 percent by weight of starch, said starch comprising from 20 to 100 percent by weight of at least one cationic starch, wherein said liquid starch composition is characterized in that a 25 percent by weight starch solids dispersion has a 25° C. viscosity of from 500 to 2500 cps both initially, and also upon storage at room temperature for 90 days.

2. The liquid starch composition of claim 1 wherein said cationic starch is derived from a starch source having at least 90 percent amylopectin.

3. The liquid starch composition of claim 1 wherein said viscosity at 25° C. is from 1000 to 2000 cps.

4. The liquid starch composition of claim 1 wherein said cationic starch comprises a quaternary ammonium salt.

5. The liquid starch composition of claim 1 wherein said cationic starch is from 1 to 20 percent cationically substituted.

6. The liquid starch composition of claim 1 wherein said composition has a solids level of from 10 to 50 percent.

7. The liquid starch composition of claim 6 wherein said composition has a solids level of from 15 to 35 percent.

8. The liquid composition of claim 1 wherein said starch comprises from 5 to 75 percent by weight of an alkyl or alkenyl succinic anhydride (ASA) modified starch.

9. The liquid starch composition of claim 1 wherein said starch comprises at least one non-ionic starch.

10. A paper or paperboard coating composition comprising:
a) 0.5 to 25 percent by weight of a starch blend comprising from 25 to 95 percent by weight of at least one cationic starch, and from 5 to 75 percent by weight of at least one alkenyl succinic anhydride (ASA) modified starch.
b) 25 to 75 percent by weight pigment; and
c) water.

11. The coating composition of claim 10, wherein said starch blend has a water fluidity (WF) of from 60 to 80.

12. The coating composition of claim 10 wherein said alkenyl succinic anhydride modified starch comprises octenyl succinic anhydride modified starch.

13. The coating composition of claim 10 wherein said degree of substitution on said ASA starch is from 0.005 to 0.10.

14. The coating composition of claim 10 wherein said starch blend is based on starches having at least 90 percent by weight of amylopectin.

15. The coating composition of claim 10 wherein said starch blend comprises from 50 to 90 weight percent of cationic starch, and from 10 to 50 weight percent of ASA starch.

16. The coating composition of claim 11 wherein said starch blend comprises from 70 to 90 weight percent of cationic starch, and from 10 to 30 weight percent of ASA starch.

17. The coating composition of claim 10 wherein said starch blend comprises from 30 to 70 weight percent of cationic starch, and from 30 to 70 weight percent of ASA starch.

18. The coating composition of claim B wherein said composition is free of non-ionic modified starch.

19. The coating composition of claim B further comprising from 2 to 20 percent by weight of at least one synthetic binder.

20. A coated paper or paperboard comprising a paper or paperboard having coated thereon on at least one surface a coating composition comprising a starch blend comprising:
1) from 25 to 95 weight percent of one or more cationic starch; and
2) from 5 to 75 percent by weight of one or more alkyl or alkenyl succinic anhydride (ASA) starch;
wherein said weight percent is based on the total amount of starch.

20. The coated paper or paperboard of claim 20 wherein said coating comprises from 5 to 95 percent by weight of pigment, and from 1 to 9 percent by weight of said starch blend, based on the dry coating weight.

21. The coated paper or paperboard of claim 20, wherein said paper or paperboard is an ink-jet paper or a paper for the printing of photographic images.

22. A process for producing a coated paper comprising applying to a sized paper web a coating composition comprising a starch blend comprising:
1) from 25 to 95 weight percent of one or more cationic starch; and
2) from 5 to 75 percent by weight of one or more alkyl or alkenyl succinic anhydride (ASA) starch; wherein said weight percent is based on the total amount of starch.
